(19) United States
(12) Patent Application Publication
(10) Pub. No.: US 2026/0168812 A1
(43) Pub. Date: Jun. 18, 2026

(54) METHODS AND SYSTEMS FOR RENDERING INDICATORS FOR A TARGET IN A MAP

(71) Applicant: Supercell Oy, Helsinki (FI)

(72) Inventor: Jonathan Dower, Helsinki (FI)

(73) Assignee: Supercell Oy, Helsinki (FI)

(21) Appl. No.: 18/979,017

(22) Filed: Dec. 12, 2024

(51) Int. Cl. G01C 21/36; A63F 13/5372; A63F 13/5378; G06T 7/13; G06T 11/00

(52) U.S. Cl. CPC G01C 21/367; A63F 13/5372; A63F 13/5378; G06T 7/13; G06T 11/00; G06T 2200/24; G06T 2207/20101; G06T 2207/30204; G06T 2210/12

(57) ABSTRACT

Disclosed is a method (100) and a system (200) for rendering indicators for a target in a map (220) of a user interface (210). The method comprises defining a target location (X1, Y1) on the map and defining a target area boundary (222) surrounding the target location, in which a center point (X2, Y2) of the target area boundary is offset from the target location by a predetermined maximum distance. Upon determining that a current location of a user-controllable object (214) is within the target area boundary, a target area indicator (224) is rendered along the target area boundary. When the distance between the current location and target location becomes less than a predetermined discovery distance (R), a target indicator (226) is rendered at the target location on the map.

### TECHNICAL FIELD

The present disclosure relates to methods for rendering indicators for a target in a map. Moreover, the present disclosure relates to systems for rendering indicators for a target in a map. Furthermore, the present disclosure relates to computer program products for rendering indicators for a target in a map.

### BACKGROUND

Map-based user interfaces are widely used in various applications including gaming applications, navigation systems, and location-based services. These interfaces typically display various targets or points of interest on a map, allowing users to locate and interact with them through a user-controllable object. Such interfaces are particularly prevalent in gaming applications where players need to discover and interact with various in-game objects, and in navigation applications where users need to locate specific destinations or points of interest.

A significant technical problem in map-based user interfaces arises when displaying multiple target locations simultaneously. When exact positions of all targets are immediately visible on the map, the interface becomes cluttered and difficult to read, particularly on devices with limited screen space such as mobile phones or navigation systems. In gaming applications, immediate disclosure of exact target locations diminishes the user experience by removing the element of discovery and exploration. Additionally, in navigation-focused applications, displaying too many precise target locations at once can overwhelm users and make it difficult to focus on relevant information.

Conventional solutions typically implement a simple proximity-based target revelation system. In such systems, target indicators only appear when a user-controllable object comes within a predetermined distance from the target location. Some implementations gradually fade in target indicators as the user approaches, while others suddenly reveal them upon crossing a distance threshold. In gaming applications, these systems often completely hide targets until the user is within a specific radius, only then revealing their exact positions.

However, these conventional approaches have significant limitations. When the revelation distance is set too large, it defeats the purpose of progressive discovery and can make the interface cluttered. Conversely, when set too small, it becomes frustrating for users as they may pass close to a target without any indication of its presence. Furthermore, binary revelation systems (completely hidden to completely visible) create abrupt transitions that can be confusing to users and do not provide sufficient guidance during the discovery process. Current solutions also typically use static, predetermined center points for target areas, making target locations predictable and reducing engagement in applications where exploration is desired.

Therefore, in light of the foregoing discussion, there exists a need for an improved method and system for rendering target indicators in map-based user interfaces. Such a solution should provide clear guidance to users while maintaining engagement, particularly in gaming applications, and should effectively manage interface complexity without compromising usability. The solution should also address the limitations of current proximity-based revelation systems while providing a more refined and engaging target discovery experience.

### SUMMARY

The aim of the present disclosure is to provide a method and a system for rendering target indicators in a user interface to improve target discovery mechanics while maintaining user engagement. The aim of the disclosure is achieved by a method and a system for rendering indicators for a target in a map as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is a flowchart illustrating steps involved in a method for rendering indicators for a target in a map, in accordance with an embodiment of the present disclosure;

FIG. 2A is a simplified schematic diagram of a system for rendering indicators for a target in a map, in accordance with an embodiment of the present disclosure;

FIG. 2B is an exemplary view showing a map rendered in a user interface with a target presence indicator, in accordance with an embodiment of the present disclosure;

FIG. 2C is an exemplary view showing the map rendered in the user interface with a target area indicator along a target area boundary, in accordance with an embodiment of the present disclosure;

FIG. 2D is a schematic diagram showing a mechanism for discovery of a target on the map, in accordance with an embodiment of the present disclosure;

FIG. 2E is a schematic diagram showing a mechanism for defining a target area boundary on the map, in accordance with an embodiment of the present disclosure;

FIG. 2F is a schematic diagram showing progression in discovery of the target on the map, in accordance with an embodiment of the present disclosure;

FIG. 2G is a schematic diagram showing coordinate relationships for a target location, in accordance with an embodiment of the present disclosure;

FIG. 2H is a schematic diagram showing a mechanism for generation of a target area boundary using a circular boundary with a centre point placement, in accordance with an embodiment of the present disclosure;

FIG. 2I is a schematic diagram showing the mechanism for generation of the target area boundary using the circular boundary with different centre point placement, in accordance with an embodiment of the present disclosure;

FIG. 2J is a schematic diagram showing a mechanism for generation of the target area boundary using a square boundary with a centre point placement, in accordance with an embodiment of the present disclosure; and

FIG. 2K is a schematic diagram showing the mechanism for generation of the target area boundary using the square boundary with a different centre point placement, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method for rendering indicators for a target in a map, the method comprising:
defining a target location on the map;
defining a target area boundary surrounding the target location in the map, wherein a centre point of the target area boundary is offset from the target location by a predetermined maximum distance;
rendering the map in a user interface;
receiving a current location of a user-controllable object on the map;
determining whether the current location is within the target area boundary;
in response to determining that the current location is within the target area boundary:
   rendering a target area indicator along the target area boundary; and
   determining a distance between the current location and the target location; and
in response to determining that the distance is less than a predetermined discovery distance, rendering a target indicator at the target location on the map.

The present method provides an improved mechanism for progressive target discovery that enhances user engagement while maintaining usability. By implementing a two-stage discovery process with an intermediate target area indicator, the method creates an engaging discovery experience while providing sufficient guidance to users. The target area indicator provides a clear search boundary when users are in proximity to the target, while the offset centre point ensures that the exact target location remains uncertain until final discovery, maintaining challenge and engagement. This synergistic combination of features results in a technically improved user interface that balances immediate usability with sustained user interest.

In a second aspect, the present disclosure provides a system for rendering indicators for a target in a map, the system comprising:
a user device configured to:
   render the map in a user interface;
   receive user inputs for controlling a user-controllable object on the map; and
   update a current location of the user-controllable object based on the user inputs; and
a server communicatively coupled to the user device via a communication network, the server configured to:
   define a target location on the map;
   define a target area boundary surrounding the target location in the map, wherein a centre point of the target area boundary is offset from the target location by a predetermined maximum distance;
   determine whether the current location is within the target area boundary;
   in response to determining that the current location is within the target area boundary:
      instruct the user device to render a target area indicator along the target area boundary; and
      determine a distance between the current location and the target location; and
   in response to determining that the distance is less than a predetermined discovery distance, instruct the user device to render a target indicator at the target location on the map.

The system provides an architecture for implementing the progressive target discovery mechanism in a distributed computing environment. The user device handles the real-time rendering and interaction aspects, while the server manages the complex calculations for target area boundaries and discovery thresholds. This distribution of processing responsibilities enables smooth operation even on devices with limited computational resources. By splitting the workload between client and server components, the system achieves optimal performance while maintaining the engaging discovery mechanics. The ability of the server to dynamically generate offset centre points and manage target boundaries, combined with local handling of rendering and input processing by the user device, creates a synergistic interaction that provides responsive and engaging user experience without compromising performance.

In the context of the present disclosure, the “method for rendering” encompasses a sequence of technical steps for generating and displaying visual elements on a user interface in a specific order and manner to achieve a particular visual effect or user experience. This includes calculations, determinations, and display operations required to present visual information effectively. The term “rendering” as used herein refers to the process of generating and displaying visual elements on a user interface. This includes, but is not limited to, drawing graphical elements, updating visual representations, and managing the visibility and appearance of various interface components.

Further, term “map” as used herein refers to a visual representation of a two-dimensional or three-dimensional space displayed on a user interface. The map may represent a physical geographic area, a virtual environment, or any other spatial domain within which targets and user-controllable objects can be positioned and displayed. The term “indicators” as used herein refers to visual elements displayed on a user interface that represent or signal the presence and/or location of objects or points of interest. These indicators may include, but are not limited to, symbols, icons, shapes, boundaries, or other graphical elements that convey information about target presence or location to a user. The term “target” as used herein refers to an object, location, or point of interest within an application that a user may need to discover, locate, or interact with. A target may represent, for example, a destination, a collectible item, a game objective, or any other point of significance within the application context.

The term “target location” as used herein refers to specific coordinates or position within the map where a target is placed. The target location is defined by a precise point in the coordinate system of the map, although this exact position may not be immediately visible to users. The target location on the map is defined according to specific terrain constraints to ensure proper placement and accessibility of the target. The process of defining a target location involves analysing the terrain characteristics at potential locations within the map coordinate system. The target location must be situated on a permitted terrain type, which comprises areas designated as valid for target placement.

In an embodiment, the target location is defined based on one or more terrain constraints, wherein the terrain constraints comprise:
the target location is on a permitted terrain type;
the target location maintains a minimum distance from water; and
the target location is on a substantially flat surface.

That is, in applications involving islands or terrestrial environments, the permitted terrain type includes sand or solid ground surfaces that can accommodate the target. The target location may need to maintain the minimum distance from water bodies or water features present on the map, ensuring that targets are not placed in inaccessible or impractical positions. This minimum distance constraint prevents scenarios where targets may be unreachable by the user-controllable object due to water obstruction. Additionally, the target location may need to be on the substantially flat surface, meaning the terrain at the selected coordinates does not include significant elevation changes, walls, or steps that would impede access to the target. The substantially flat surface requirement ensures that the target can be properly rendered and accessed when discovered. These terrain constraints are applied during the initial placement of the target and remain fixed throughout the discovery process. When multiple potential target locations meet these terrain constraints, a specific location may be selected randomly from among the valid positions. The target location coordinates are stored and used as a reference point for subsequent calculations of target area boundaries and distance measurements relative to the user-controllable object.

Further, the target area boundary is defined as a region that encompasses the target location on the map. The predetermined maximum distance is established as a fixed value that determines the maximum allowable separation between the target location and the centre point of the target area boundary. The centre point of the target area boundary is positioned at coordinates distinct from the target location coordinates, with the offset between these two points not exceeding the predetermined maximum distance. This creates a configuration where the target location and the centre point of the target area boundary are separated by a distance that is equal to or less than the predetermined maximum distance. The target area boundary is then constructed around the centre point in a manner that ensures the target location falls within the bounded area. The relationship between the target location, the centre point, and the predetermined maximum distance establishes the parameters for generating the target area boundary. This boundary serves as a search region within which the target is located, while maintaining uncertainty about the exact target position within the boundary.

In an embodiment, defining the target area boundary comprises:
selecting a random point within the predetermined maximum distance from the target location; and
generating the target area boundary using the random point as the centre point such that the target location falls within the target area boundary.

The process of defining the target area boundary involves a two-step coordinate-based operation. The first step includes selecting the random point in the coordinate space of the map. This random point selection is constrained such that the distance between the selected point and the target location does not exceed the predetermined maximum distance. The selection of this random point creates a variable offset from the target location, while ensuring the offset remains within the predetermined maximum distance constraint. As used herein, the term “random point” refers to a point selected using any deterministic or non-deterministic selection process that provides a point within a predefined area or distance from a reference location, where the position of the selected point cannot be predicted solely from knowledge of the reference location. The selection process may utilize various randomization algorithms, pseudo-random number generators, or other selection mechanisms as may be contemplated by a person skilled in the art.

The second step includes using this randomly selected point as the centre point for generating the target area boundary. The target area boundary is generated outward from this centre point in a manner providing that the target location falls within the bounded area. This method of using a randomly selected point as the centre point, rather than centring the boundary on the target location, ensures that while the target is always contained within the boundary, the target location can be at any position within the bounded area relative to the centre point. For a given target location, each time a target area boundary is defined, a different random point may be selected as the centre point, enabling variation in how the boundary is positioned relative to the target location while maintaining the constraint that the target location must fall within the boundary.

In present embodiments, the target area boundary comprises one of: a circular boundary or a polygonal boundary.

The target area boundary can be implemented in two distinct geometric forms. In a first implementation, the target area boundary is in the form of circular boundary defined by a radius extending from the centre point. The circular boundary implementation utilizes the centre point as the origin of a circle, with the radius selected to ensure the target location falls within the circular area. In a second implementation, the target area boundary is in the form of polygonal boundary defined by multiple linear segments connected to form an enclosed shape around the centre point. The polygonal boundary implementation utilizes the centre point as a reference for constructing a multi-sided shape, such as a square, with dimensions selected to ensure the target location falls within the enclosed area. Herein, for example, a square boundary can be implemented where the predetermined maximum distance equals half the length of the square edge. Both forms of boundary provide a defined area for indicating the region within which the target is located, with the specific form of boundary being selected based on implementation requirements.

Rendering the map in the user interface includes generating a visual representation of a spatial environment on a display device of the computing device. The map is rendered to show terrain features including permitted terrain types such as sand or ground surfaces, water bodies, and topographical elements such as flat surfaces and elevated areas. The rendering the map involves the process of generating and displaying visual elements related to the map on the user interface. The rendering process may include, but is not limited to, converting map data into visible elements, applying visual styles and textures, implementing zoom levels, and updating the display in response to user interactions or system events. The rendered map may represent real-world geography, fictional environments, or combinations thereof.

In an embodiment, rendering the map in the user interface comprises rendering a target presence indicator on the map to indicate existence of the target therein.

In the present configuration, prior to the user-controllable object entering a specific region of the map, the target presence indicator is rendered on the map. The target presence indicator comprises a visual element that signals to the user that a target exists in that region of the map, without revealing the exact location of the target. For example, when the map represents an environment with multiple islands, the target presence indicator is rendered to show that a specific island contains a target, while the user is still at sea or approaching the island. When the user-controllable object enters the region indicated by the target presence indicator, the target presence indicator is removed from the map. This initial indication of target presence, followed by removal upon region entry, creates a transition point for implementing the subsequent target discovery mechanics. The target presence indicator serves as an initial guidance mechanism, informing users about regions of the map that warrant exploration without compromising the discovery aspects of the target location.

The method further comprises receiving the current location of the user-controllable object on the map. This process includes continuously monitoring position coordinates of the user-controllable object within the coordinate system of the map. As used herein, the “user-controllable object” refers to any visual element in the user interface whose position, movement, or orientation can be modified through user input. The user-controllable object may take various forms including, but not limited to, a character avatar, cursor, vehicle, or other graphical element that responds to user control through input mechanisms such as touch screen interactions, keyboard commands, mouse movements, controller inputs, or other input methods. The “current location” refers to the presently determined position of the user-controllable object, within the coordinate system of the rendered map at any given moment in time. The current location may be expressed as coordinates (e.g., X, Y coordinates in a two-dimensional map, and may be continuously updated in response to object movement or user input. The user-controllable object is rendered at a location on the map corresponding to coordinates that are updated based on user inputs received through the user interface. The location of the user-controllable object includes both position coordinates and orientation information, with the orientation being indicated by a sector showing the direction the user-controllable object is facing relative to the map coordinates. When the user-controllable object moves on the map, through user manipulation of control elements in the user interface, the current location is updated to reflect the new position coordinates. This location tracking helps to maintain accurate positioning data necessary for implementing target discovery.

The method further comprises determining whether the current location is within the target area boundary. This process includes performing a spatial calculation to evaluate the position of the user-controllable object relative to the target area boundary. The calculation involves measuring the distance between the current location coordinates of the user-controllable object and the centre point of the target area boundary. This measured distance is compared against the dimensions of the target area boundary to determine if the user-controllable object has entered the bounded region. The determination process continuously updates as the current location of the user-controllable object changes, enabling real-time evaluation of whether the user-controllable object enters or exits the target area boundary. When the current location is determined to be within the target area boundary, this determination triggers the subsequent steps in the target discovery process.

When the current location of the user-controllable object is determined to be within the target area boundary, the method initiates the rendering operation to display the target area indicator along the target area boundary. That is, upon determination that the current location of the user-controllable object is within the target area boundary, a conditional rendering operation is executed. This operation includes generating and displaying the target area indicator, which is rendered specifically along the target area boundary. The target area indicator may be rendered using the same dimensional parameters as the defined target area boundary, including the previously established centre point and boundary. The rendering operation displays the target area indicator at the coordinates that define the target area boundary, creating a visual representation of the bounded region. The target area indicator is continuously rendered and updated as long as the condition of the current location being within the target area boundary remains true. This creates a direct spatial relationship between the position of the user-controllable object and the visibility of the target area indicator.

In an embodiment, rendering the target area indicator comprises displaying a visual boundary indicating an area within which the target is located.

The rendering process of the target area indicator generates a visual element in the form of the visual boundary that traces the exact shape and dimensions of the target area boundary using the previously defined centre point and boundary parameters. For example, if the user-controllable object enters an island containing a target, the target area indicator is displayed showing the bounded search area. The target area indicator in the form of the visual boundary rendered along the periphery of the target area boundary helps to delineate the search region within which the target is located, providing users with a defined region within which to search for the target while maintaining uncertainty about the exact target location within the bounded area. The target area indicator remains visible as long as the user-controllable object remains within the target area boundary, providing continuous visual feedback about the search area. The target area indicator serves as an intermediate discovery stage, confirming proximity to the target while maintaining engagement through controlled uncertainty about the exact target position.

The method further comprises determining the distance between the current location and the target location. This step includes performing continuous spatial calculations using the coordinate system of the map. The calculation measures the direct linear distance between the coordinates of the user-controllable object at the current location and the defined coordinates of the target location. This distance determination is executed each time the current location updates, ensuring real-time distance tracking between the user-controllable object and the target location. The measured distance value is used as a parameter for evaluating proximity conditions for revelation of the target.

When the calculated distance becomes less than the predetermined discovery distance, the method involves executes a rendering operation to display the target indicator at the exact coordinates of the target location on the map. The target indicator is rendered at the exact coordinates of the target location, serving as a precise indication of target position. The term “predetermined discovery distance” as used herein refers to a fixed threshold distance value that determines when the exact position of a target is revealed to a user, wherein this distance is measured between the current location of the user-controllable object and the target location. Further, the term “target location” as used herein refers to the exact coordinates on the map where the target is positioned, defined by specific coordinate values in coordinate system of the map and subject to terrain constraints. It may be noted that this rendering operation occurs immediately upon the distance condition being met, creating a direct relationship between proximity of the user-controllable object and visibility of the target.

In present embodiments, the predetermined discovery distance is selected based on at least one of: a type of the target and a discovery difficulty setting.

When the predetermined discovery distance is selected based on the type of the target, different distance values are assigned for different categories of targets within the application. For example, certain types of targets may require closer proximity for discovery while others become visible from greater distances. When the predetermined discovery distance is selected based on the discovery difficulty setting, the distance value is adjusted according to defined difficulty levels configured in the application. A higher difficulty setting results in a smaller predetermined discovery distance, requiring the user-controllable object to move closer to the target location before the target indicator is rendered. Conversely, a lower difficulty setting implements a larger predetermined discovery distance, allowing the target indicator to be rendered when the user-controllable object is farther from the target location.

In an embodiment, rendering the target indicator comprises:
removing the target area indicator from the map; and
displaying a visual marker at the target location on the map indicating position of the target.
The rendering of the target indicator employs a specific sequence for managing visual elements on the map display. The first operation includes removing the target area indicator from the map that eliminates the visual reference related to bounded search area from the user interface. This removal ensures that the previous search area guidance is no longer visible once the target location is to be revealed. The second operation includes generating and displaying the visual marker at the exact coordinates of the target location on the map. This visual marker is rendered with distinct graphical properties (such as, a pin on the map or the like) that clearly indicate the specific position where the target is located. The sequential execution of these two operations creates a transition in the visual feedback provided to users, from indication of the broader search area to the exact target.

In some embodiments, the method further comprises:
detecting movement of the user-controllable object;
continuously updating the distance between the current location and the target location based on the movement; and
dynamically updating the rendering of the target indicator based on the updated distance.

The method implements a continuous movement tracking and distance update mechanism that operates during execution of the application. The detection of movement includes monitoring changes in the coordinates of the user-controllable object on the map in response to user inputs received through the user interface. When movement is detected, the coordinate position of the user-controllable object is updated in the coordinate system of the map. Based on this detected movement, the method executes continuous distance calculations between the updated coordinates of the user-controllable object and the fixed coordinates of the target location. These distance calculations are performed each time the position of the user-controllable object changes, maintaining real-time distance values. The calculated distance values are then used to control the dynamic rendering of the target indicator. The rendering of the target indicator is updated in real-time (or near real-time) based on these distance calculations, following the defined distance thresholds and rendering rules. For example, when the updated distance becomes less than the predetermined discovery distance, the target indicator is rendered at the target location, and when the distance increases beyond the predetermined discovery distance, the target indicator is removed from display. This creates a mechanism in which the visibility of the target indicator corresponds to the current position of the user-controllable object relative to the target location.

In some embodiments, the method further comprises rendering a directional indicator to show an orientation of the user-controllable object relative to the map.

Herein, the directional indicator is rendered in conjunction with the user-controllable object on the map to provide orientation information. The directional indicator may include a sector element that extends from the location of the user-controllable object in the direction the user-controllable object is facing. The directional indicator is rendered relative to the coordinate system of the map, where, for example, the upward direction on the map corresponds to North. The rendering operation continuously updates the directional indicator as the orientation of the user-controllable object changes through user input. For instance, when the user-controllable object orientation changes from facing North to facing any other direction on the map, the sector element updates accordingly to maintain directional representation. The directional indicator remains continuously visible during movement of the user-controllable object, providing constant feedback about orientation relative to the map coordinates.

The present disclosure also relates to the system for rendering indicators for the target in the map as described above. Various embodiments and variants disclosed above, with respect to the aforementioned method, apply mutatis mutandis to the system.

The system for rendering indicators for the target in the map implements a client-server architecture comprising the user device and the server connected through the communication network. The distribution of processing responsibilities between the user device and the server enables efficient execution of the target discovery mechanism while optimizing performance and resource utilization.

Herein, the user device may include a computing device having a display unit for presenting the user interface. The user device executes multiple functions in the process for rendering indicators for the target in the map. The user device, first, renders the map in the user interface, generating the visual representation of the spatial environment including terrain features. The user device also receives user inputs through input mechanisms such as touch screen interactions, keyboard commands, or other control elements that enable manipulation of the user-controllable object. The user device further updates the current location of the user-controllable object in real-time based on these user inputs, maintaining accurate positional data within the map coordinate system.

The server may include a computing system that manages the computational operations of the process for rendering indicators for the target in the map. The server connects to the user device through the communication network (such as, Internet), enabling bi-directional data exchange. The server executes multiple functions that control the target discovery mechanism. The server defines the target location on the map. The server, then, defines the target area boundary by establishing a centre point offset from the target location, ensuring the offset does not exceed the predetermined maximum distance. The server further performs continuous spatial calculations to determine whether the current location received from the user device falls within the target area boundary.

Furthermore, the server implements a two-stage discovery process through specific instructions to the user device. In the first stage, when the server determines the current location is within the target area boundary, the server transmits instructions to the user device to render the target area indicator along the defined boundary. Simultaneously, the server calculates the distance between the current location and target location. In the second stage, when this calculated distance becomes less than the predetermined discovery distance, the server instructs the user device to render the target indicator at the precise coordinates of the target location on the map.

In an embodiment, the server is further configured to define the target area boundary by:
selecting a random point within the predetermined maximum distance from the target location; and
generating the target area boundary using the random point as the centre point such that the target location falls within the target area boundary, wherein the target area boundary comprises one of: a circular boundary or a polygonal boundary.

Herein, the server defines the target area boundary by first performing the random point selection operation within a constrained area. The server selects a random point that is positioned within the predetermined maximum distance from the target location coordinates. Using this randomly selected point as the centre point, the server generates a boundary that ensure inclusion of the target location. When generating a circular boundary, the server uses the random centre point as the origin for calculating the circular perimeter. When generating a polygonal boundary, such as a square boundary, the server positions the random point at the centre and extends the boundary edges such that the target location falls within the enclosed area, where the predetermined maximum distance equals half the edge length of the square.

In an embodiment, the server is configured to define the target location based on one or more terrain constraints, wherein the terrain constraints comprise:
the target location is on a permitted terrain type;
the target location maintains a minimum distance from water; and
the target location is on a substantially flat surface.

Herein, the server defines the target location by applying multiple terrain-based validation checks. The server first validates whether a potential target location is situated on a permitted terrain type by examining the terrain data at the specific coordinates. For example, when the map contains islands, the server confirms the location is on valid terrain such as sand surfaces. The server then calculates distances to all water bodies or features on the map to verify the target location maintains a defined minimum separation from water. The server additionally analyses the topographical data at the potential location to confirm it represents a substantially flat surface, verifying the absence of significant elevation changes, walls, or steps that would impede access to the target. These terrain constraints are applied during initial placement of the target to ensure targets are positioned in accessible locations.

In an embodiment, the user device is further configured to:
detect movement of the user-controllable object; and
transmit information about the movement to the server; and the server is further configured to:
continuously update the distance between the current location and the target location based on the movement; and
instruct the user device to dynamically update the rendering of the target indicator based on the updated distance.

The user device detects changes in position of the user-controllable object by monitoring user inputs through the user interface. When movement is detected, the user device generates movement information containing the updated coordinates and transmits this data to the server through the communication network. Upon receiving this movement information, the server executes new distance calculations between the updated current location and the fixed target location coordinates. Based on these recalculated distances, the server generates and transmits instructions to the user device for updating the rendering of the target indicator, specifying whether and how the target indicator should be displayed or modified based on the performed calculations.

In an embodiment, the server is further configured to:
prior to the current location being within the target area boundary, instruct the user device to render a target presence indicator on the map to indicate existence of the target therein;
when the current location is within the target area boundary, instruct the user device to render the target area indicator as a visual boundary indicating an area within which the target is located; and
when the distance is less than the predetermined discovery distance:
   instruct the user device to remove the target area indicator from the map; and
   instruct the user device to display a visual marker at the target location indicating position of the target.

The server manages the sequence for target discovery through multiple instruction sets to the user device. In the initial phase, when the current location is outside the target area boundary, the server instructs the user device to render the target presence indicator, such as an icon indicating a target exists on a specific island. When the server determines the current location of the user-controllable object is within the target area boundary, new instructions are transmitted to the user device to remove the presence indicator and render the target area indicator, creating a visual boundary showing the search area. When the server calculates that the distance has decreased below the predetermined discovery distance, further instructions are sent to the user device to first remove the target area indicator from display, and then render the visual marker at the exact coordinates of the target location. This sequence creates controlled transitions between different stages of target discovery.

In certain embodiments, the target indicator serves a dual role as both a navigational guide and a collectible object within applications, as an example in gaming environments. This multifunctional design enables users to not only locate specific areas on a map but also interact with the target indicator to collect items necessary for completing tasks or advancing levels. In one example, by transforming the target indicator into an interactive game object, the system links map navigation with gameplay objectives, making exploration purposeful and engaging.

The target indicator provides dynamic feedback: as the user approaches, its status updates, allowing it to be “collected” upon interaction. This immediate feedback confirms task progression, enhances user engagement, and strengthens immersion by giving real-time acknowledgment of achievements. Additionally, this design reduces visual clutter by guiding users only to relevant objectives, ensuring a focused and streamlined navigation experience.

Moreover, integrating the target indicator as a collectible object encourages strategic planning. Players must efficiently navigate the map to gather multiple indicators, adding depth and challenge to gameplay. This structured approach supports adaptive difficulty, enriching the user experience by balancing accessibility with complexity. Through these interactive and strategic elements, the target indicator provides a technically enhanced system that improves both usability and engagement within the application.

Furthermore, as the target indicator is presented for the user the user can use the user interface to select the presented target indicator. The selection can invoke a signal or a function to change status of the application. Alternatively, the selection can be used to update a database or change a status of an software module. As an example the selection of the target indicator (symbol) in a user interface can increment a counter or it can be used to initiate a software module.

### DETAILED DESCRIPTION OF THE DRAWINGS

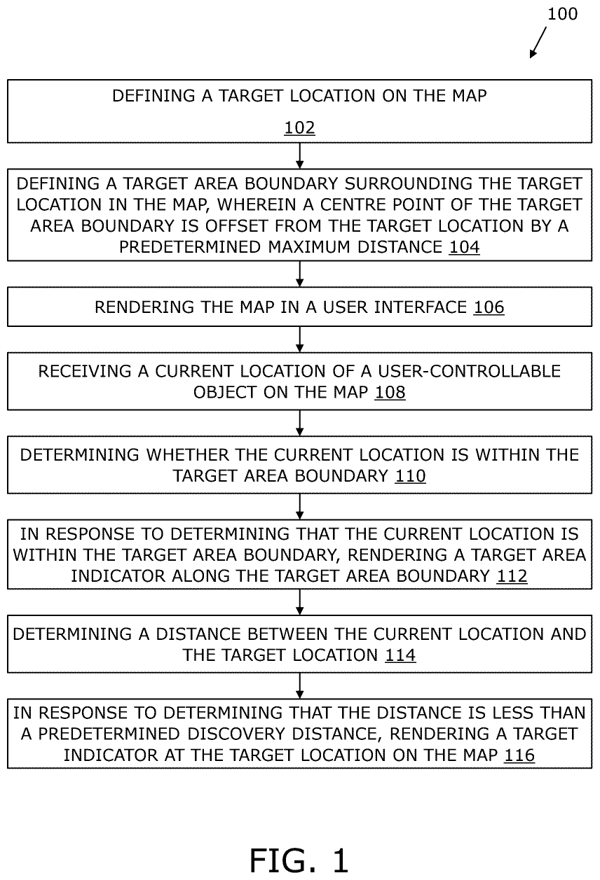

Referring to FIG. 1, illustrated is a flowchart listing steps 102-116 involved in a method 100 for rendering indicators for a target in a map, in accordance with an embodiment of the present disclosure. At step 102, the method 100 includes defining a target location on the map. At step 104, the method 100 includes defining a target area boundary surrounding the target location in the map, wherein a centre point of the target area boundary is offset from the target location by a predetermined maximum distance. At step 106, the method 100 includes rendering the map in a user interface. At step 108, the method 100 includes receiving a current location of a user-controllable object on the map. At step 110, the method 100 includes determining whether the current location is within the target area boundary. At step 112, the method 100 includes, in response to determining that the current location is within the target area boundary, rendering a target area indicator along the target area boundary. At step 114, the method 100 includes determining a distance between the current location and the target location. At step 116, the method 100 includes, in response to determining that the distance is less than a predetermined discovery distance, rendering a target indicator at the target location on the map.

It may be appreciated that the above steps are only illustrative and other alternatives can also be provided where one or more steps are added, one or more steps are removed, or one or more steps are provided in a different sequence without departing from the spirit and the scope of the present disclosure.

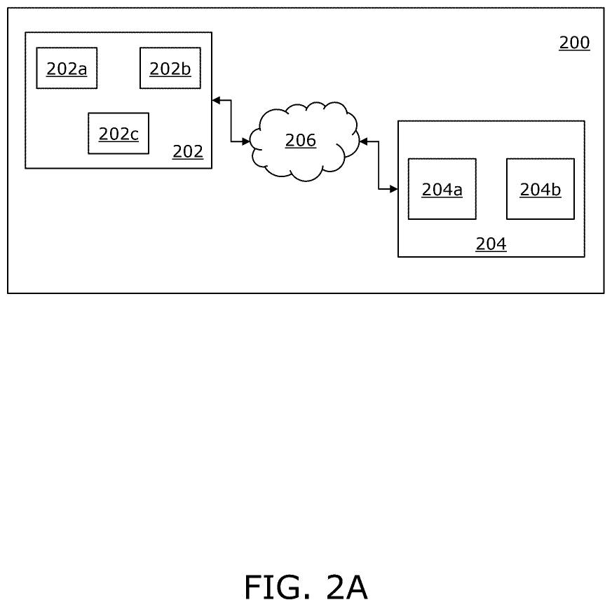

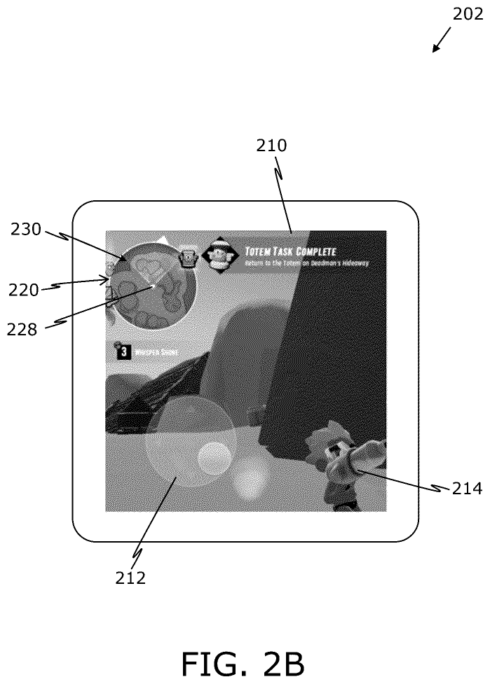

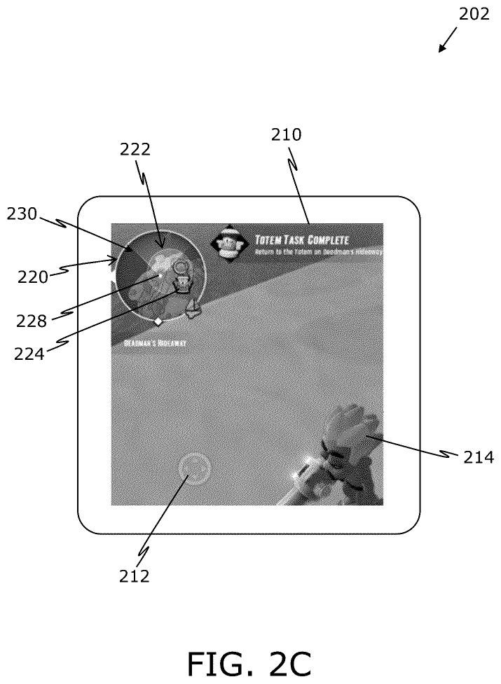

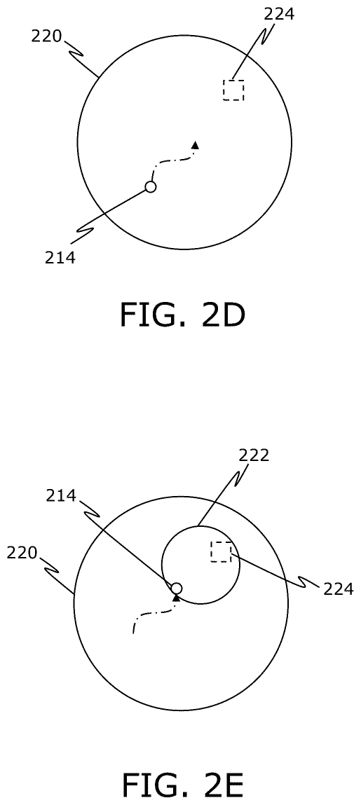

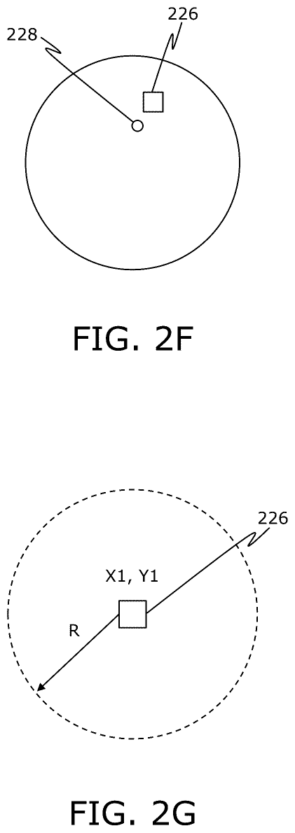

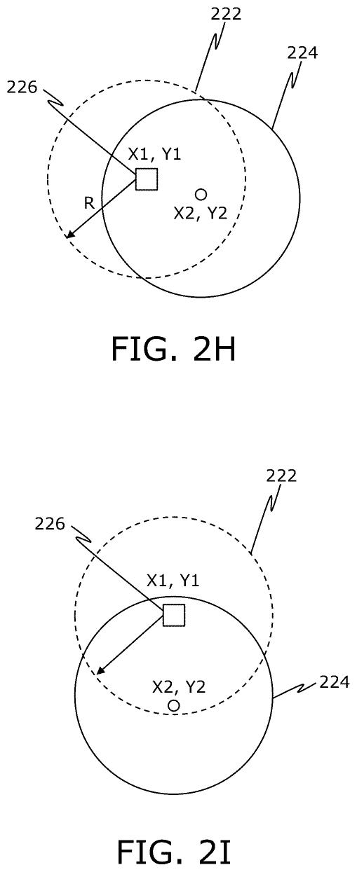

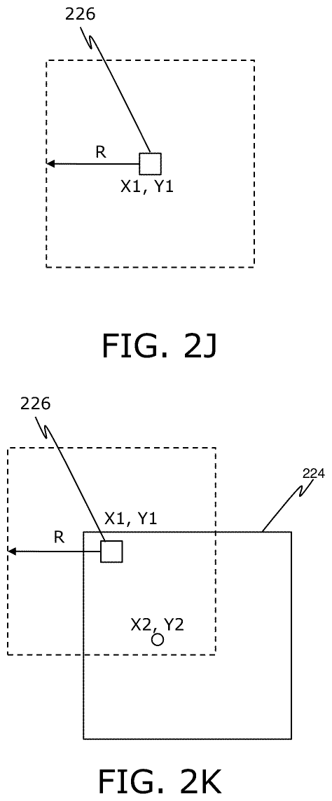

Referring to FIG. 2A, illustrated is a simplified schematic diagram illustration of a system 200 for rendering indicators for a target in a map. The user device 202 comprises a processing unit 202a, a memory unit 202b, and a display unit 202c. The processing unit 202a is configured to execute instructions stored in the memory unit 202b for rendering the map in a user interface on the display unit 202c. The memory unit 202b stores map data, user interface elements, and program instructions for controlling the user-controllable object. The display unit 202c provides the visual output for presenting the map and all rendered indicators. The server 204 comprises a processor 204a and a memory 204c. The processor 204a executes instructions stored in the memory 204c for performing spatial calculations and managing target discovery mechanics. The memory 204c stores data related to target locations, boundary definitions, and discovery parameters. The communication network 206 facilitates bi-directional data exchange between the user device 202 and the server 204. The communication network 206 enables transmission of user input data from the user device 202 to the server 204 and rendering instructions from the server 204 to the user device 202.

The components of the system 200 work in coordination to implement the target discovery process, with the user device 202 handling local rendering and input processing while the server 204 manages the computational and logical operations of the target discovery mechanics.

Referring to FIG. 2B, illustrated is an exemplary view displayed on the user device 202, showing a map 220 rendered in a user interface 210. A user-controllable object 214 is positioned at a current location on the map 220. A control element 212 is provided in the user interface 210 for receiving user inputs to control movement of the user-controllable object 214. A directional indicator 230 shows the orientation of the user-controllable object 214 relative to the map 220. A target presence indicator 228 is rendered on the map 220 to indicate the existence of a target in a specific region of the map 220.

Referring to FIG. 2C, illustrated is another exemplary view displayed on the user device 202, showing the map 220 rendered in the user interface 210. As shown, the user-controllable object 214 has moved to a new current location within a target area boundary 222. The directional indicator 230 continues to show the orientation of the user-controllable object 214. The control element 212 is displayed in the user interface 210 for receiving user inputs. The target presence indicator 228 is also displayed on the map 220 to indicate the existence of the target therein. A target area indicator 224 is rendered along the target area boundary 222, indicating the area within which the target is located.

Referring to FIG. 2D, illustrated is a schematic diagram showing mechanism for discovery of the target on the map 220. The target area indicator 224 is represented indicative of a hidden target location, while a directed path (indicated by dashed-dotted arrow) shows movement of the user-controllable object 214 from a starting position.

Referring to FIG. 2E, illustrated is a schematic diagram showing mechanism for defining the target area boundary 222 on the map 220. Herein, the target area indicator 224 is utilized to define a visual boundary, corresponding to the target area boundary 222, which represents the search area, while maintaining uncertainty about the exact target location. The directional path (again indicated by dashed-dotted arrow) shows the completed movement of the user-controllable object 214 in the map 220.

Referring to FIG. 2F, illustrated is a schematic diagram showing progression in discovery of the target on the map 220. Herein, the user-controllable object 214 has moved to a location leading to discovery of the target. In such case, a target indicator 226 is rendered at the target location once the user-controllable object 214 comes within the predetermined distance of the target location. The circular boundary remains visible to show the relationship between the search area and the discovered target location.

Referring to FIG. 2G, illustrated is a schematic diagram showing coordinate relationships for the target location. A target indicator 226 is shown at coordinates (X1, Y1), which represents the target location. A radius ‘R’ represents the predetermined discovery distance from the target location (X1, Y1), illustrating how the predetermined discovery distance ‘R’ defines the threshold at which the target indicator 226 becomes visible on the map.

Referring to FIG. 2H, illustrated is a schematic diagram showing mechanism for generation of the target area boundary 222 using a circular boundary. The target location is shown at coordinates (X1, Y1) with the target indicator 226. A randomly selected centre point (X2, Y2) is positioned within the distance ‘R’ from the target location (X1, Y1). The target area indicator 224 is rendered on the circular boundary centred at coordinates (X2, Y2), such that the target location (X1, Y1) falls within the bounded area.

Referring to FIG. 2I, illustrated is a schematic diagram showing mechanism for generation of the target area boundary 222 using a circular boundary with different centre point placement. The coordinates of the target location (X1, Y1) are marked by the target indicator 226. The target area indicator 224 is rendered on the circular boundary with centre point at coordinates (X2, Y2). This demonstrates that different random centre point selections within radius ‘R’ create different but valid target area boundaries that always contain the target location.

Referring to FIG. 2J, illustrated is a schematic diagram showing mechanism for generation of the target area boundary 222 using a polygonal boundary. Herein, specifically, the target area boundary 222 is a square boundary. The target location (X1, Y1) is marked by the target indicator 226, with a distance ‘R’ determining the size of the square boundary. In this example, the distance ‘R’ is ½ of edge of the square boundary; i.e., distance from the target indicator 226 is ‘R’.

Referring to FIG. 2K, illustrated is another schematic diagram showing mechanism for generation of the target area boundary 222 using a polygonal boundary with different centre point placement. Herein, the target location (X1, Y1) is marked by the target indicator 226, while the target area indicator 224 is rendered as the square boundary. A centre point (shown as a circle) is positioned at coordinates (X2, Y2) within a distance ‘R’ from the target location (X1, Y1). This demonstrates that the polygonal boundary maintains the same target containment principles as the circular boundary while using a different geometric form.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method (100) for rendering indicators for a target in a map (220), the method (100) comprising:
defining a target location (X1, Y1) on the map (220);
defining a target area boundary (222) surrounding the target location (X1, Y1) in the map (220), wherein a centre point (X2, Y2) of the target area boundary (222) is offset from the target location (X1, Y1) by a predetermined maximum distance;
rendering the map (220) in a user interface (210);
receiving a current location of a user-controllable object (214) on the map (220);
determining whether the current location is within the target area boundary (222);
in response to determining that the current location is within the target area boundary (222):
rendering a target area indicator (224) along the target area boundary (222); and
determining a distance between the current location and the target location (X1, Y1); and
in response to determining that the distance is less than a predetermined discovery distance (R), rendering a target indicator (226) at the target location (X1, Y1) on the map (220).

2. The method (100) of claim 1, wherein defining the target area boundary (222) comprises:
selecting a random point within the predetermined maximum distance from the target location (X1, Y1); and
generating the target area boundary (222) using the random point as the centre point (X2, Y2) such that the target location (X1, Y1) falls within the target area boundary (222).

3. The method (100) of any of claims 1 or 2, wherein the target area boundary (222) comprises one of: a circular boundary or a polygonal boundary.

4. The method (100) of any of preceding claims, wherein rendering the map (220) in the user interface (210) comprises rendering a target presence indicator (228) on the map (220) to indicate existence of the target therein.

5. The method (100) of any of preceding claims, wherein rendering the target area indicator (224) comprises displaying a visual boundary indicating an area within which the target is located.

6. The method (100) of any of preceding claims, wherein rendering the target indicator (226) comprises:
removing the target area indicator (224) from the map (220); and
displaying a visual marker at the target location (X1, Y1) on the map (220) indicating position of the target.

7. The method (100) of any of preceding claims, wherein the target location (X1, Y1) is defined based on one or more terrain constraints, wherein the terrain constraints comprise:
the target location (X1, Y1) is on a permitted terrain type;
the target location (X1, Y1) maintains a minimum distance from water; and
the target location (X1, Y1) is on a substantially flat surface.

8. The method (100) of any of preceding claims, wherein the predetermined discovery distance (R) is selected based on at least one of: a type of the target and a discovery difficulty setting.

9. The method (100) of any of preceding claims, further comprising:
detecting movement of the user-controllable object (214);
continuously updating the distance between the current location and the target location (X1, Y1) based on the movement; and
dynamically updating the rendering of the target indicator (226) based on the updated distance.

10. The method (100) of any of preceding claims, further comprises rendering a directional indicator (230) to show an orientation of the user-controllable object (214) relative to the map (220).

11. A system for rendering indicators for a target in a map (220), the system comprising:
a user device (202) configured to:
render the map (220) in a user interface (210);
receive user inputs for controlling a user-controllable object (214) on the map (220); and
update a current location of the user-controllable object (214) based on the user inputs; and
a server (204) communicatively coupled to the user device (202) via a communication network (206), the server (204) configured to:
define a target location (X1, Y1) on the map (220);
define a target area boundary (222) surrounding the target location (X1, Y1) in the map (220), wherein a centre point (X2, Y2) of the target area boundary (222) is offset from the target location (X1, Y1) by a predetermined maximum distance;
determine whether the current location is within the target area boundary (222);
in response to determining that the current location is within the target area boundary (222):
instruct the user device (202) to render a target area indicator (224) along the target area boundary (222); and
determine a distance between the current location and the target location (X1, Y1); and
in response to determining that the distance is less than a predetermined discovery distance (R), instruct the user device (202) to render a target indicator (226) at the target location (X1, Y1) on the map (220).

12. The system according to claim 11, wherein the server (204) is further configured to define the target area boundary (222) by:
selecting a random point within the predetermined maximum distance from the target location (X1, Y1); and
generating the target area boundary (222) using the random point as the centre point (X2, Y2) such that the target location (X1, Y1) falls within the target area boundary (222), wherein the target area boundary (222) comprises one of: a circular boundary or a polygonal boundary.

13. The system according to any of claims 11-12, wherein the server (204) is configured to define the target location (X1, Y1) based on one or more terrain constraints, wherein the terrain constraints comprise:
the target location (X1, Y1) is on a permitted terrain type;
the target location (X1, Y1) maintains a minimum distance from water; and
the target location (X1, Y1) is on a substantially flat surface.

14. The system according to any of claims 11-13, wherein:
the user device (202) is further configured to:
detect movement of the user-controllable object (214); and
transmit information about the movement to the server (204); and
the server (204) is further configured to:
continuously update the distance between the current location and the target location (X1, Y1) based on the movement; and
instruct the user device (202) to dynamically update the rendering of the target indicator (226) based on the updated distance.

15. The system according to any of claims 11-14, wherein the server (204) is further configured to:
prior to the current location being within the target area boundary (222) instruct the user device (202) to render a target presence indicator (228) on the map (220) to indicate existence of the target therein;
when the current location is within the target area boundary (222), instruct the user device (202) to render the target area indicator (224) as a visual boundary indicating an area within which the target is located; and
when the distance is less than the predetermined discovery distance (R):
instruct the user device (202) to remove the target area indicator (224) from the map (220); and
instruct the user device (202) to display a visual marker at the target location (X1, Y1) indicating position of the target.
